(19) United States
(12) Patent Application Publication
(10) Pub. No.: US 2024/0178416 A1
(43) Pub. Date: May 30, 2024

(54) FUEL CELL SYSTEM AND FUEL SUPPLYING CONTROL METHOD THEREOF

(71) Applicant: HYUNDAI MOBIS CO., LTD., Seoul (KR)

(72) Inventor: Yong Hee LEE, Yongin-si (KR)

(73) Assignee: HYUNDAI MOBIS CO., LTD., Seoul (KR)

(21) Appl. No.: 18/366,115

(22) Filed: Aug. 7, 2023

(30) Foreign Application Priority Data
Nov. 29, 2022 (KR) 10-2022-0162740

(51) Int. Cl. H01M 8/04082; B64D 41/00; H01M 8/0438; H01M 8/04746; H01M 16/00

(52) U.S. Cl. CPC H01M 8/04201; B64D 41/00; H01M 8/04425; H01M 8/04753; H01M 16/006; B64D 2041/005; H01M 2220/20; H01M 2250/20

(57) ABSTRACT

A fuel cell system includes a three-way valve installed on a hydrogen supply line between a fuel cell stack and a hydrogen tank, a first hydrogen supply valve installed on a first hydrogen supply line branching off by the three-way valve and configured to variably adjust a hydrogen supply pressure, a second hydrogen supply valve installed on a second hydrogen supply line branching off by the three-way valve and configured to adjust the hydrogen supply pressure to a constant pressure, and a controller configured to control a supply of hydrogen to one of the first hydrogen supply line and the second hydrogen supply line according to a state of the hydrogen tank while the fuel cell stack operates.

### CROSS-REFERENCE TO RELATED APPLICATION

This application claims the benefit under 35 USC § 119 (a) of priority to Korean Patent Application No. 10-2022-0162740, filed in the Korean Intellectual Property Office on Nov. 29, 2022, the entire contents of which are incorporated herein by reference for all purposes.

### TECHNICAL FIELD

The present disclosure relates to a fuel cell system and a fuel supplying control method thereof.

### BACKGROUND

Fuel cell systems may generate electric energy using fuel cell stacks. For example, when hydrogen is used as a fuel for the fuel cell stack, the fuel cell stack may be alternative to solving global environmental problems, and thus R&D on the fuel cell systems has been continuously carried out.

The fuel cell system may include a fuel cell stack that generates electrical energy, a fuel supply device that supplies a fuel (hydrogen) to the fuel cell stack, an air supply device that supplies, to the fuel cell stack, oxygen in the air, which is an oxidizing agent required for electrochemical reaction, a thermal management system (TMS) that removes reaction heat of the fuel cell stack to the outside of the system, controls an operating temperature of the fuel cell stack, and performs a water management function, and a fuel cell system controller that controls the overall operation of the fuel cell system. In the fuel cell system, electricity is generated by reacting hydrogen that is a fuel and oxygen in the air, and heat and water as reaction by-products are discharged.

In recent years, the fuel cell systems have been applied to various transportation devices such as flight vehicles as well as vehicles.

The fuel cell system applied to the flight vehicle supplies power to the flight vehicle by storing hydrogen in a hydrogen tank and supplying the stored hydrogen to the fuel cell stack to generate power. In this case, when the supply of the hydrogen is stopped due to a decrease in the hydrogen fuel in the flight vehicle, the flight vehicle may crash.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a fuel cell system includes a three-way valve installed on a hydrogen supply line between a fuel cell stack and a hydrogen tank, a first hydrogen supply valve installed on a first hydrogen supply line branching off by the three-way valve and configured to variably adjust a hydrogen supply pressure, a second hydrogen supply valve installed on a second hydrogen supply line branching off by the three-way valve and configured to adjust the hydrogen supply pressure to a constant pressure, and a controller configured to control a supply of hydrogen to one of the first hydrogen supply line and the second hydrogen supply line according to a state of the hydrogen tank while the fuel cell stack operates.

The three-way valve may include a first port through which the supply of hydrogen being supplied from the hydrogen tank is introduced, a second port configured to variably adjust a pressure of the hydrogen introduced through the first port and discharge the pressure-adjusted hydrogen through the first hydrogen supply line, and a third port configured to adjust the pressure of the hydrogen introduced through the first port and discharge the pressure-adjusted hydrogen through the second hydrogen supply line.

The controller may control opening or closing of one or more of the first port, the second port, and the third port by determining whether an internal pressure and a state of fuel (SoF) of the hydrogen tank satisfy a reference pressure condition.

When the internal pressure of the hydrogen tank exceeds a reference pressure or the SoF of the hydrogen tank exceeds a reference value, the controller may determine that the reference pressure condition is satisfied.

When the state of the hydrogen tank satisfies the reference pressure condition, the controller may open the first port and the second port and closes the third port.

When the second port is opened, the controller may control a duty of the first hydrogen supply valve to 100% and adjusts the duty according to a hydrogen supply state.

The first hydrogen supply valve may be a solenoid valve.

Ehen the state of the hydrogen tank does not satisfy the reference pressure condition, the controller may close the second port and opens the third port.

When the second port is closed, the controller may control a duty of the first hydrogen supply valve to 0%.

When the third port is opened, the second hydrogen supply valve may adjust the pressure of the hydrogen to the constant pressure and supplies the pressure-adjusted hydrogen to the fuel cell stack.

The second hydrogen supply valve may be a constant pressure regulating valve.

Ehen the hydrogen is supplied through the second hydrogen supply valve, the controller may operate in a low output hydrogen constant pressure mode and transmits a load decrease request signal to a vehicle controller of a flight vehicle employing the fuel cell system.

When operating in the low output hydrogen constant pressure mode, the controller may initiate an emergency landing using the vehicle controller.

The fuel cell system may include a high-voltage battery configured to be charged by power generated by the fuel cell stack during the emergency landing.

The high-voltage battery may supply driving power to the flight vehicle during the emergency landing.

Responsive to a completion of the emergency landing, the controller may output a message requesting charging of the hydrogen tank.

In a general aspect, here is provided a processor-implemented method including identifying a state of a hydrogen tank during an operation of a fuel cell stack powered by hydrogen from the hydrogen tank and controlling a supply of the hydrogen to one of a first hydrogen supply line including a first hydrogen supply valve configured to variably adjust a hydrogen supply pressure and a second hydrogen supply line including a second hydrogen supply valve configured to adjust the hydrogen supply pressure to a constant pressure, according to the state of the hydrogen tank.

The identifying of the state of the hydrogen tank may include determining whether a reference pressure condition of the hydrogen tank is satisfied when an internal pressure of the hydrogen tank exceeds a reference pressure or a state of fuel (SoF) of the hydrogen tank exceeds a reference value when the internal pressure and the SoF of the hydrogen tank are identified.

The controlling of the supply of the hydrogen may include controlling the supply of the hydrogen through the first hydrogen supply line when the state of the hydrogen tank satisfies the reference pressure condition.

The controlling of the supply of the hydrogen may include controlling the supply of the hydrogen through the second hydrogen supply line when the state of the hydrogen tank does not satisfy the reference pressure condition.

Responsive to the state of the hydrogen tank not satisfying the reference pressure condition, the method may include operating in a low output hydrogen constant pressure mode when the hydrogen is supplied through the second hydrogen supply line, guiding an emergency landing of a flight vehicle employing the fuel cell stack, charging a high-voltage battery using power generated by the fuel cell stack while the emergency landing of the flight vehicle is attempted, and supplying driving power from the high-voltage battery to the flight vehicle.

In a general aspect, here is provided a processor-implemented method including controlling, responsive to a determined state of the hydrogen tank, a first port through which a supply of hydrogen being supplied from a hydrogen tank is introduced, controlling, responsive to the determined state of the hydrogen tank, a second port configured to adjust a pressure of the hydrogen introduced through the first port and discharge the pressure-adjusted hydrogen through a first hydrogen supply line to a fuel cell stack, controlling, responsive to the determined state of the hydrogen tank, a third port configured to adjust the pressure of the hydrogen introduced through the first port and discharge the pressure-adjusted hydrogen through a second hydrogen supply line to the fuel cell stack, and entering a low output hydrogen constant pressure mode responsive to the determined state of the hydrogen tank not satisfying a reference pressure condition, the low output hydrogen constant pressure mode including controlling the third port to supply the hydrogen through the second hydrogen supply line and charging a high-voltage battery using power generated by the fuel cell stack.

The low output hydrogen constant pressure mode may include initiating an emergency landing of a flight vehicle receiving power from the fuel cell stack.

The low output hydrogen constant pressure mode may include supplying driving power to a flight vehicle employing the fuel cell stack using the high-voltage battery.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a fuel cell system according to an embodiment of the present disclosure;

FIG. 2A is a view illustrating a control operation of a three-way valve according to a first embodiment of the present disclosure;

FIG. 2B is a view illustrating a hydrogen supply line according to the first embodiment of the present disclosure;

FIG. 3A is a view illustrating a control operation of a three-way valve according to a second embodiment of the present disclosure;

FIG. 3B is a view illustrating a hydrogen supply line according to the second embodiment of the present disclosure; and

FIGS. 4 to 5 are views illustrating an operation flow of a fuel supplying control method of the fuel cell system according to the embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component (s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof. A fuel cell system according to the present disclosure may be applied to a flight vehicle flying in the sky. The fuel cell system according to the present disclosure may be provided inside or outside the flight vehicle, and an arrangement position thereof is not limited to any one. As an example, a fuel cell applied to the fuel cell system according to the present disclosure may be a polymer electrolyte membrane fuel cell (PEMFC).

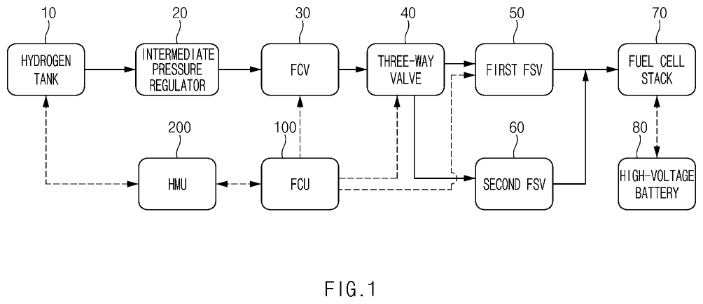

FIG. 1 is a view illustrating a fuel cell system according to an embodiment of the present disclosure.

Referring to FIG. 1, the fuel cell system may include a fuel cell stack 70, and a hydrogen supply line which is connected to a hydrogen electrode and through which hydrogen moves, an air supply line which is connected to an air electrode of the fuel cell stack 70 and through which air supplied to the fuel cell stack 70 moves, and a discharge line and a purge line for discharging moisture (water), unreacted gas, or the like, which are reaction by-products, to the outside are connected to the fuel cell stack 70.

The fuel cell stack 70 (or referred to as a “fuel cell”) may be formed in a structure that may generate electricity through an oxidation-reduction reaction of a fuel (e.g., the hydrogen) and an oxidizing agent (e.g., the air). As an example, the fuel cell stack 70 may be a polymer electrolyte membrane fuel cell (PEMFC).

The fuel cell stack 70 may include a membrane electrode assembly (MEA) to which catalytic electrode layers in which electrochemical reactions occur are attached on both sides with respect to a center of an electrolyte membrane through which hydrogen ions move, a gas diffusion layer (GDL) that serves to evenly distribute reactive gases and transfer generated electrical energy, a gasket and a fastening mechanism for maintaining airtightness and appropriate fastening pressures of the reactive gases and cooling water, and a bipolar plate that moves the reactive gases and the cooling water.

In the fuel cell stack 70, the hydrogen as the fuel and the air (oxygen) as the oxidizing agent are supplied to an anode and a cathode of the MEA through a passage of the bipolar plate. The hydrogen may be supplied to the anode that is the hydrogen electrode and the air may be supplied to the cathode that is the air electrode.

The hydrogen supplied to the anode is decomposed into hydrogen ions (protons) and electrons by a catalyst of electrode layers formed on both sides of the electrolyte membrane. Among them, only the hydrogen ions may be selectively transferred to the cathode through the electrolyte membrane that is a positive ion exchange membrane, and at the same time, the electrons may be transferred to the cathode through the GDL and the bipolar plate that are conductors. In the cathode, the hydrogen ions supplied through the electrolyte membrane and the electrons transferred through the bipolar plate may react with oxygen in the air supplied to the cathode by an air supply device to produce water. Due to movement of the hydrogen ions occurring in this case, a flow of the electrons through an external conducting wire may occur, and a current may be generated by the flow of the electrons.

Further, the fuel cell system may include a hydrogen tank 10 connected to the hydrogen supply line and may further include an intermediate pressure regulator 20 installed between the hydrogen tank 10 and the fuel cell stack 70, a fuel cut-off valve (FCV) 30, a first fuel supply valve (FSV) 50, and a second FSV 60.

The hydrogen tank 10 is a hydrogen storage for storing the fuel, that is, the hydrogen, supplied to the hydrogen electrode of the fuel cell stack 70, and discharges the stored hydrogen to the hydrogen supply line when the supply of the hydrogen to the fuel cell stack 70 is required. The hydrogen tank 10 may be charged with charging hydrogen introduced through a hydrogen charging port. Further, a temperature sensor (not illustrated) for detecting an internal temperature of the hydrogen tank 10 may be additionally installed inside the hydrogen tank 10.

Further, a hydrogen tank valve (not illustrated) may be installed at an outlet of the hydrogen tank 10. Here, the hydrogen tank valve may adjust the amount of hydrogen supplied from the hydrogen tank 10. The hydrogen tank valve may be opened or closed according to a control signal of a hydrogen manufacturing unit (HMU) 200.

Here, the HMU 200 is a controller that performs overall functions related to the supply of the hydrogen. Here, the HMU 200 may be a hardware device such as a processor or a central processing unit (CPU) or a program implemented by the processor.

The HMU 200 identifies a state of the hydrogen tank 10 in real time and identifies whether the state of the hydrogen tank 10 satisfies a condition for controlling the supply of the hydrogen. As an example, the HMU 200 may identify a pressure and a temperature in the hydrogen tank 10, a hydrogen concentration and a state of fuel (SoF) of the hydrogen tank 10, and the like.

Accordingly, the HMU 200 may control operations for supplying the hydrogen according to the state of the hydrogen tank 10. Further, the HMU 200 may provide state information of the hydrogen tank 10 to a fuel cell control unit (FCU) 100.

When the hydrogen tank valve is opened according to the control signal of the HMU 200, the supply of the hydrogen to the fuel cell stack 70 starts. In this case, when a pressure of the hydrogen introduced into the fuel cell stack 70 is high, internal rupture and damage may occur, and thus management of the pressure of the supplied hydrogen is very important.

Accordingly, the intermediate pressure regulator 20 serves to adjust (decrease) the pressure of the hydrogen supplied along the hydrogen supply line connecting the hydrogen tank 10 and the fuel cell stack 70 when the hydrogen tank valve is open. Here, the intermediate pressure regulator 20 decreases a pressure of a high-pressure hydrogen gas supplied from the hydrogen tank 10 into a reference pressure “P” and provides the pressure-decreased hydrogen gas to the FCV 30. In this case, the intermediate pressure regulator 20 may be arranged together with an intermediate pressure sensor (not illustrated) that detects the pressure of the hydrogen and a venting valve (not illustrated) that is opened for a certain period of time to adjust the pressure of the gas when the pressure detected by the intermediate pressure sensor is not adjusted to a pressure within a usable range in the fuel cell stack 70.

The FCV 30 serves to block the supply of the hydrogen to the fuel cell stack 70. As an example, the FCV 30 may be open in a state in which the fuel cell system is in an on state and closed in a state in which the fuel cell system is in an off state. The FCV 30 may be disposed between the intermediate pressure regulator 20 and the first FSV 50 and the second FSV 60 in the hydrogen supply line.

A three-way valve 40 that switches the hydrogen supply line may be additionally installed between the FCV 30 and the first FSV 50 and the second FSV 60.

Here, the three-way valve 40 may include a first port 41 which is connected to an outlet of the FCV 30 and into which the hydrogen in the hydrogen supply line is introduced, a second port 42 that discharges the hydrogen introduced into the first port 41 to the first FSV 50 through a branched first hydrogen supply line, and a third port 43 that discharges the hydrogen introduced into the first port 41 to the second FSV 60 through a branched second hydrogen supply line.

The first port 41 of the three-way valve 40 may be always open when the hydrogen is supplied, and the hydrogen supply line may be switched as the second port 42 and the third port 43 are opened or closed.

As an example, when the second port 42 is open and the third port 43 is closed, the hydrogen may be introduced into the fuel cell stack 70 through the first FSV 50. In contrast, when the third port 43 is open and the second port 42 is closed, the hydrogen may be introduced into the fuel cell stack 70 through the second FSV 60.

Here, the FCV 30 and the three-way valve 40 may be opened or closed according to a control signal of the FCU 100. As an example, the FCV 30 and the three-way valve 40 may be opened by an ON control signal of the FCU 100 and may be closed by an OFF control signal thereof.

Here, the FCU 100 is connected to respective components of the fuel cell system and performs overall functions related to management and operation of the fuel cell system. The FCU 100 may be an upper controller. Here, the FCU 100 may be a hardware device such as a processor or a central processing unit (CPU) or a program implemented by the processor.

When the fuel cell system operates, the FCU 100 may control a start-up and driving operation of the fuel cell stack 70 based on the state information of the hydrogen tank 10 received from the HMU 200. Further, the FCU 100 may control operations of the FCV 30, the three-way valve 40, and the first FSV 50 based on the state information of the hydrogen tank 10.

The FCU 100 may control opening or closing of each port of the three-way valve 40 according to an internal pressure or the SoF of the hydrogen tank 10. Accordingly, the hydrogen may be supplied to the fuel cell stack 70 through the first FSV 50 connected to the first hydrogen supply line or supplied to the fuel cell stack 70 through the second FSV 60 connected to the second hydrogen supply line.

As an example, when the fuel cell system operates and when the state of the hydrogen tank 10 satisfies a reference pressure condition, the FCU 100 may perform a control to open the first port 41 and the second port 42 of the three-way valve 40 and to close the third port 43 thereof.

Here, when the internal pressure of the hydrogen tank 10 exceeds the reference pressure “P” or the SoF of the hydrogen tank 10 exceeds a reference value “Q”, the FCU 100 may determine that the reference pressure condition of the hydrogen tank 10 is satisfied.

Since the flight vehicle operates using the hydrogen stored in the hydrogen tank 10, the fuel is required to provide power to the flight vehicle until the flight vehicle completely makes an emergency landing on land in an emergency situation. Thus, the SoF of the hydrogen tank 10 is included in the reference pressure condition of the hydrogen tank 10, and thus the fuel for the emergency landing may be secured.

Meanwhile, when the internal pressure of the hydrogen tank 10 is smaller than or equal to the reference pressure “P” and the SoF of the hydrogen tank 10 is smaller than and equal to the reference value “Q”, the FCU 100 may determine that the reference pressure condition of the hydrogen tank 10 is not satisfied.

When the fuel cell system operates and when the reference pressure condition of the hydrogen tank 10 is not satisfied, the FCU 100 may perform a control to open the first port 41 and the third port 43 of the three-way valve 40 and to close the second port 42 thereof. In this case, the FCU 100 may operate in a low output hydrogen constant pressure mode. Here, the low output hydrogen constant pressure mode may refer to a mode in which the fuel cell system operates in a low output state with the hydrogen at a constant pressure.

The first FSV 50 is disposed between the FCV 30 and the fuel cell stack 70 in the hydrogen supply line and serves to adjust the pressure of the hydrogen supplied to the fuel cell stack 70. As an example, the first FSV 50 may be opened to increase the pressure of the hydrogen when a pressure of the hydrogen supply line decreases and may be closed to decrease the pressure of the hydrogen when the pressure of the hydrogen supply line increases.

The first FSV 50 is disposed between the FCV 30 and the fuel cell stack 70 in the hydrogen supply line. In this case, the first FSV 50 may be connected to the first hydrogen supply line branching off by the second port 42 of the three-way valve 40.

The first FSV 50, which is a high-pressure valve, serves to adjust the pressure of the hydrogen supplied to the fuel cell stack 70. Here, since the first hydrogen supply line is a path through which the hydrogen moves when the pressure of the hydrogen exceeds a reference pressure, the first FSV 50, which is a high-pressure valve, may be implemented as a solenoid valve. As an example, the first FSV 50 may be controlled to be opened to increase the pressure of the hydrogen when the pressure of the hydrogen supply line decreases and to be closed to decrease the pressure of the hydrogen when the pressure of the hydrogen supply line increases.

Here, the first FSV 50 may be opened or closed by a control signal of the FCU 100.

The second FSV 60 is disposed between the FCV 30 and the fuel cell stack 70 in the hydrogen supply line and is connected in parallel to the first FSV 50. In this case, the second FSV 60 may be connected to the second hydrogen supply line branching off by the third port 43 of the three-way valve 40.

The second FSV 60 serves to adjust the pressure of the hydrogen supplied to the fuel cell stack 70 to the constant pressure. Here, since the second hydrogen supply line is a path through which the hydrogen moves when the pressure of the hydrogen is smaller than or equal to the reference pressure, the second FSV 60, which is a low-pressure valve, may be implemented as a constant pressure regulating valve.

As an example, when the hydrogen is introduced through an inlet, the second FSV 60 adjusts the introduced hydrogen to the constant pressure (e.g., 1.2 bar) and discharges the introduced hydrogen to the fuel cell stack 70 connected to an outlet. Here, unlike the solenoid valve, the second FSV 60 does not adjust an opening degree of the valve but adjusts the hydrogen to the constant pressure and discharges the hydrogen, and thus no separate control is required.

The fuel cell stack 70 generates power using the hydrogen supplied through the first FSV 50 or the second FSV 60. Here, the fuel cell stack 70 may be connected to a high-voltage battery 80.

The high-voltage battery 80 may provide auxiliary power to the fuel cell system and may be charged using energy generated by the fuel cell stack 70.

Meanwhile, when the FCU 100 operates in the low output hydrogen constant pressure mode, the high-voltage battery 80 may provide driving power for the emergency landing to the flight vehicle.

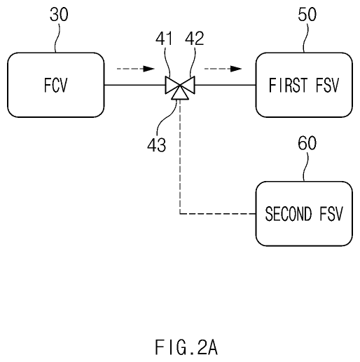

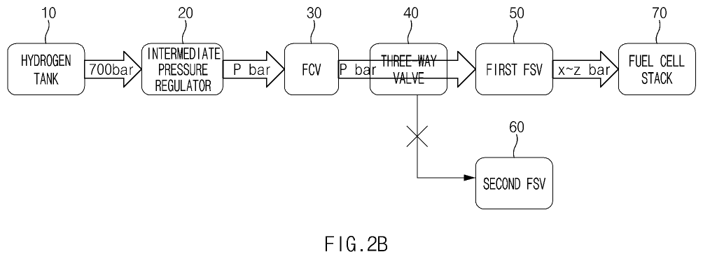

FIG. 2A is a view illustrating a control operation of a three-way valve according to a first embodiment of the present disclosure, and FIG. 2B is a view illustrating a hydrogen supply line according to the first embodiment of the present disclosure.

Referring to FIG. 2A, the FCU 100 determines whether a state of the hydrogen tank 10 satisfies the reference pressure condition by identifying the internal pressure and the SoF of the hydrogen tank 10. In this case, when the internal pressure of the hydrogen tank 10 exceeds the reference pressure “P” or the SoF of the hydrogen tank 10 exceeds the reference value “Q”, the FCU 100 determines that the reference pressure condition of the hydrogen tank 10 is satisfied.

In this way, when it is identified that the state of the hydrogen tank 10 satisfies the reference pressure condition, the FCU 100 transmits the ON control signal to the first port 41 and the second port 42 of the three-way valve 40 so as to open the first port 41 and the second port 42. In this case, as the second port 42 is opened, the hydrogen is supplied to the first FSV 50 installed on the first hydrogen supply line connected to the second port 42.

Meanwhile, the FCU 100 transmits the OFF control signal to the third port 43 of the three-way valve 40 so as to close the third port 43. In this case, as the third port 43 of the three-way valve 40 is closed, the supply of the hydrogen to the second FSV 60 installed on the second hydrogen supply line connected to the third port 43 is blocked.

Referring to FIG. 2B, when the state of the hydrogen tank 10 satisfies the reference pressure condition, the hydrogen tank 10 supplies the hydrogen having a high pressure (for example, 700 bar) to the hydrogen supply line. In this case, the intermediate pressure regulator 20 adjusts (decreases) the pressure of the hydrogen from the hydrogen tank 10 to the reference pressure “P” and discharges the pressure-decreased hydrogen gas to the FCV 30. As an example, the intermediate pressure regulator 20 decreases the pressure of the hydrogen supplied from the hydrogen tank 10 to 17 bar and discharges the pressure-decreased hydrogen to the FCV 30 connected to the outlet.

Accordingly, the FCV 30 blocks the hydrogen supply line when a predetermined event occurs, but transfers the hydrogen introduced from the intermediate pressure regulator 20 to the three-way valve 40 otherwise.

In this case, in the three-way valve 40, as illustrated in FIG. 2A, by the FCU 100, the first port 41 and the second port 42 are opened and the third port 43 is closed. Thus, the hydrogen discharged from the FCV 30 is introduced into the first FSV 50 along the first hydrogen supply line connected to the second port 42 of the three-way valve 40.

In this case, the FCU 100 controls a duty of the first FSV 50 to 100% to open the first FSV 50 so as to supply the hydrogen to the fuel cell stack 70. In this case, the FCU 100 may control the duty of the first FSV 50 according to a hydrogen supply state to adjust the opening degree of the valve. Accordingly, the first FSV 50 may transfer the hydrogen of which the pressure is adjusted to x to z bar (here, x<z), for example, 1 to 2 bar, to the fuel cell stack 70 according to the opening degree.

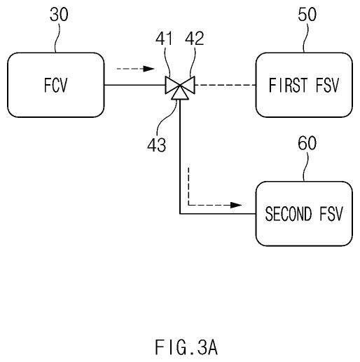

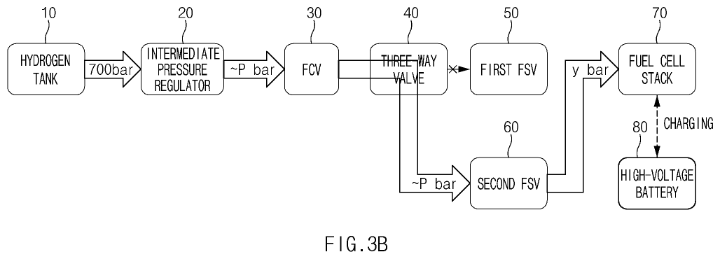

FIG. 3A is a view illustrating a control operation of a three-way valve according to a second embodiment of the present disclosure, and FIG. 3B is a view illustrating a hydrogen supply line according to the second embodiment of the present disclosure.

Referring to FIG. 3A, when the internal pressure of the hydrogen tank 10 is smaller than or equal to the reference pressure “P” and the SoF of the hydrogen tank 10 is smaller than and equal to the reference value “Q”, the FCU 100 determines that the reference pressure condition of the hydrogen tank 10 is not satisfied.

In this way, when it is identified that the state of the hydrogen tank 10 does not satisfies the reference pressure condition, the FCU 100 transmits the OFF control signal to the second port 42 to close the second port 42 and transmits the ON control signal to the third port 43 to open the third port 43.

In this case, as the second port 42 of the three-way valve 40 is closed, the supply of the hydrogen to the first FSV 50 installed on the first hydrogen supply line connected to the second port 42 is blocked. In this case, the FCU 100 may control the duty of the first FSV 50 connected to the second port 42 to 0% so as to close the first FSV 50.

Meanwhile, as the third port 43 of the three-way valve 40 is opened, the hydrogen is supplied to the second FSV 60 installed on the second hydrogen supply line connected to the third port 43.

Referring to FIG. 3B, when the state of the hydrogen tank 10 does not satisfies the reference pressure condition, the hydrogen tank 10 supplies the hydrogen having the reference pressure “P”, for example, a pressure of 17 bar or less, to the intermediate pressure regulator 20. In this case, since the pressure of the hydrogen supplied from the hydrogen tank 10 is smaller than or equal to the reference pressure “P”, the intermediate pressure regulator 20 may discharge the hydrogen to the FCV 30 without separately decreasing the pressure.

Accordingly, the FCV 30 transfers the hydrogen introduced from the intermediate pressure regulator 20 to the three-way valve 40. In this case, in the three-way valve 40, as illustrated in FIG. 3A, by the FCU 100, the first port 41 and the third port 43 are opened and the second port 42 is closed. Thus, the hydrogen discharged from the FCV 30 is introduced into the second FSV 60 along the second hydrogen supply line connected to the third port 43 of the three-way valve 40.

In this case, the second FSV 60 may adjust the pressure of the introduced hydrogen to the constant pressure and transfer the pressure-adjusted hydrogen to the fuel cell stack 70. Here, the constant pressure may refer to a force applied in a direction perpendicular to a direction in which the hydrogen flows and may be determined as a fixed value of y bar (e.g., 1.2 bar). Here, a value of y may be determined within a range of x<y<z.

However, since the hydrogen having the constant pressure of 1.2 bar is supplied to the fuel cell stack 70, this does not meet the demand for high power of a load motor of the flight vehicle. Accordingly, when the state of the hydrogen tank 10 does not satisfies the reference pressure condition, the FCU 100 may operate in the low output hydrogen constant pressure mode and transmit a load output decrease request signal to a vehicle controller (not illustrated). Accordingly, the vehicle controller may decrease the output of the load motor according to the request of the FCU 100 and attempt the emergency landing.

While the vehicle controller attempts the emergency landing, the FCU 100 may charge the high-voltage battery 80 using the output of the fuel cell stack 70 and drive the load motor of the flight vehicle using the power charged in the high-voltage battery 80.

In this case, while the flight vehicle attempts the emergency landing, the FCU 100 may modify a power control plan of electric components within a range in which power consumption of the electric components is minimized. As an example, the FCU 100 may terminate operations of the electric components except for a bidirectional high voltage direct current (DC) converter (BHDC) to minimize the power consumption and set a voltage of the high-voltage battery 80 applied to the BHDC to be higher than that of the fuel cell stack 70.

When the emergency landing of the flight vehicle is completed, the FCU 100 terminates related operations. In this case, the FCU 100 may output a message that requests charging of the hydrogen.

An operation flow of the fuel cell system according to the present disclosure as configured above will be described below in more detail.

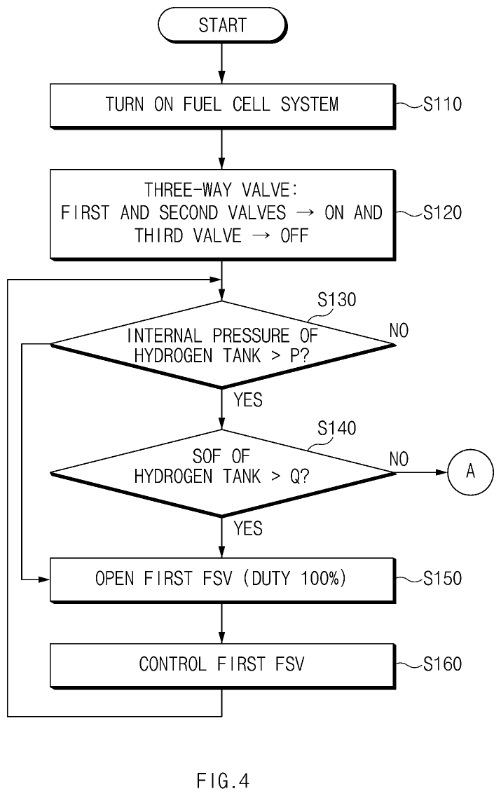

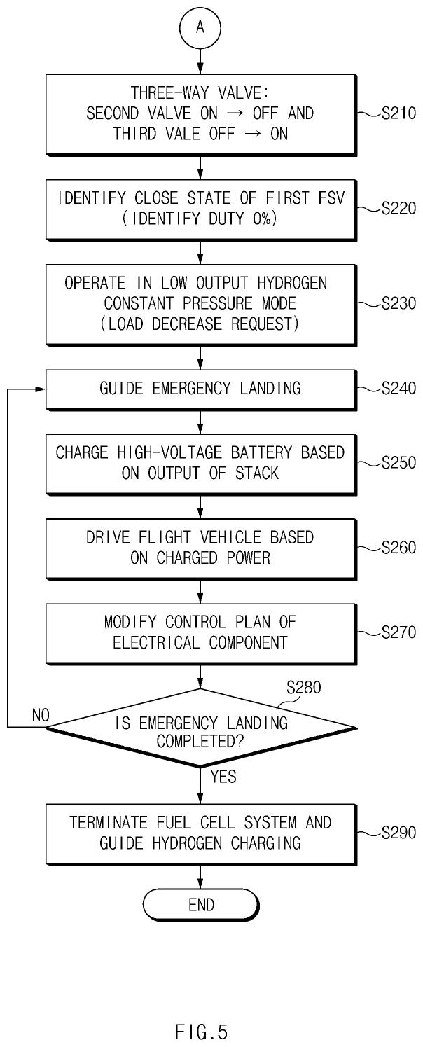

FIGS. 4 to 5 are views illustrating an operation flow of a fuel supplying control method of the fuel cell system according to the embodiment of the present disclosure.

First, referring to FIG. 4, when the fuel cell system is in an ON state for flight of the flight vehicle (S110), the first port 41 and the second port 42 of the three-way valve 40 is controlled to be turned on, and the third port 43 is controlled to be turned off (S120). Here, a control operation of operation S120 may be performed as default when the fuel cell system is turned on. Accordingly, the first port 41 and the second port 42 are opened, and the third port 43 is closed.

In this case, the fuel cell system determines whether the internal pressure and the SoF of the hydrogen tank 10 satisfy the reference pressure condition. The fuel cell system may determine that the reference pressure condition is satisfied when the internal pressure of the hydrogen tank 10 exceeds the reference pressure “P” (S130) or when the SoF of the hydrogen tank 10 exceeds the reference value “Q” (S140).

Accordingly, when the internal pressure or the SoF of the hydrogen tank 10 satisfies the reference pressure condition, the fuel cell system controls the duty of the first FSV 50 installed on the first hydrogen supply line connected to the second port 42 to 100% so as to open the first FSV 50. Due to operation S150, the hydrogen of which a pressure is adjusted to a predetermined pressure while passing through the first FSV 50 is supplied to the fuel cell stack 70.

Thereafter, the fuel cell system may control the first FSV 50 according to the hydrogen supply state through the first hydrogen supply line (S160).

Meanwhile, in operation S130 and operation S140, when it is identified that the internal pressure of the hydrogen tank 10 is smaller than or equal to the reference pressure “P” and the SoF of the hydrogen tank 10 is smaller than or equal to the reference value “Q”, the fuel cell system may determine that the reference pressure condition is not satisfied.

In this case, in operation S120 of FIG. 4, the first port 41 and the second port 42 are controlled to be turned on, and the third port 43 is controlled to be turned off. Thus, when the internal pressure and the SoF of the hydrogen tank 10 do not satisfy the reference pressure condition, as illustrated in FIG. 5, the fuel cell system controls the second port 42 of the three-way valve 40 to be turned off and controls the third port 43 to be turned on (S210). Accordingly, the second port 42 is closed, and the third port 43 is opened.

In operation S210, as the second port 42 is closed, the fuel cell system controls the duty of the first FSV 50 installed on the first hydrogen supply line connected to the second port 42 to 0% so as to close the first FSV 50 (S220).

Further, in operation S210, as the third port 43 of the three-way valve 40 is opened, the hydrogen is supplied to the second FSV 60 installed on the second hydrogen supply line connected to the third port 43. Accordingly, the second FSV 60 adjusts the pressure of the introduced hydrogen to a predetermined pressure and supplies the pressure-adjusted hydrogen to the fuel cell stack 70. Here, the second FSV 60, which is a constant pressure regulating valve, adjusts the pressure of the introduced hydrogen to a constant pressure regardless of the pressure of the input hydrogen and supplies the pressure-adjusted hydrogen to the fuel cell stack 70. Thus, even when the internal pressure of the hydrogen tank 10 is smaller than or equal to the reference pressure “P” and the SoF of the hydrogen tank 10 is smaller than or equal to the reference value “Q”, the hydrogen having a constant pressure may be supplied to the fuel cell stack 70.

However, when the reference pressure condition of the hydrogen tank 10 is not satisfied, the hydrogen having a pressure that is lower than the reference value “Q” is supplied to the fuel cell stack 70. Thus, the fuel cell system operates in the low output hydrogen constant pressure mode and requests the vehicle controller to decrease the load output (S230).

Further, when operating in the low output hydrogen constant pressure mode, the fuel cell system guides the emergency landing using the vehicle controller (S240). Accordingly, while the emergency landing is attempted by the vehicle controller, the fuel cell system charges the high-voltage battery 80 using the output of the fuel cell stack 70 (S250) and drives the flight vehicle using the charging power of the high-voltage battery 80 (S260). Thus, the vehicle controller of the flight vehicle may fly using the power supplied from the high-voltage battery 80 as a power source and attempt the emergency landing at a target position.

In this case, the fuel cell system may modify the power control plan of the electric components such as the BHDC to minimize power consumption in order to minimize the power consumption in the low output hydrogen constant pressure mode (S270).

Thereafter, when the emergency landing is completed (S280), the charging of the hydrogen may be guided while the fuel cell system is terminated (S290).

As described above, in the fuel cell system and the fuel supplying control method according to the embodiment of the present disclosure, when the internal pressure and the SoF of the hydrogen tank do not satisfy the reference pressure condition while the flight vehicle equipped with the fuel cell system flies, to prevent the hydrogen from not being supplied through the solenoid valve, the hydrogen supply line is switched to the hydrogen supply line in which the constant pressure regulating valve is installed, and thus the supply of the hydrogen to the fuel cell stack is maintained even in a low pressure state, so that the emergency landing may be achieved.

According to an embodiment of the present disclosure, a hydrogen supply line in which a solenoid valve for supplying hydrogen branches off, a constant pressure regulating valve is additionally disposed on the branched hydrogen supply line, and thus the hydrogen supply line is easily switched according to an internal pressure and a state of fuel (SoF) of a hydrogen tank while a flight vehicle flies.

Further, according to an embodiment of the present disclosure, when a state of the hydrogen tank does not satisfy a reference value as the SoF stored in the hydrogen tank decreases during flying, a current mode is switched to the hydrogen supply line in which the constant pressure regulating valve is installed, supply of hydrogen is maintained while an emergency landing is attempted, and thus a risk of a falling accident may be minimized.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A fuel cell system, comprising:
a three-way valve installed on a hydrogen supply line between a fuel cell stack and a hydrogen tank;
a first hydrogen supply valve installed on a first hydrogen supply line branching off by the three-way valve and configured to variably adjust a hydrogen supply pressure;
a second hydrogen supply valve installed on a second hydrogen supply line branching off by the three-way valve and configured to adjust the hydrogen supply pressure to a constant pressure; and
a controller configured to control a supply of hydrogen to one of the first hydrogen supply line and the second hydrogen supply line according to a state of the hydrogen tank while the fuel cell stack operates.

2. The fuel cell system of claim 1, wherein the three-way valve includes:
a first port through which the supply of hydrogen being supplied from the hydrogen tank is introduced;
a second port configured to variably adjust a pressure of the hydrogen introduced through the first port and discharge the pressure-adjusted hydrogen through the first hydrogen supply line; and
a third port configured to adjust the pressure of the hydrogen introduced through the first port and discharge the pressure-adjusted hydrogen through the second hydrogen supply line.

3. The fuel cell system of claim 2, wherein the controller controls opening or closing of one or more of the first port, the second port, and the third port by determining whether an internal pressure and a state of fuel (SoF) of the hydrogen tank satisfy a reference pressure condition.

4. The fuel cell system of claim 3, wherein, when the internal pressure of the hydrogen tank exceeds a reference pressure or the SoF of the hydrogen tank exceeds a reference value, the controller determines that the reference pressure condition is satisfied.

5. The fuel cell system of claim 4, wherein, when the state of the hydrogen tank satisfies the reference pressure condition, the controller opens the first port and the second port and closes the third port.

6. The fuel cell system of claim 5, wherein, when the second port is opened, the controller controls a duty of the first hydrogen supply valve to 100% and adjusts the duty according to a hydrogen supply state.

7. The fuel cell system of claim 1, wherein the first hydrogen supply valve comprises a solenoid valve.

8. The fuel cell system of claim 3, wherein, when the state of the hydrogen tank does not satisfy the reference pressure condition, the controller closes the second port and opens the third port.

9. The fuel cell system of claim 8, wherein, when the second port is closed, the controller controls a duty of the first hydrogen supply valve to 0%.

10. The fuel cell system of claim 8, wherein, when the third port is opened, the second hydrogen supply valve adjusts the pressure of the hydrogen to the constant pressure and supplies the pressure-adjusted hydrogen to the fuel cell stack.

11. The fuel cell system of claim 1, wherein the second hydrogen supply valve comprises a constant pressure regulating valve.

12. The fuel cell system of claim 10, wherein, when the hydrogen is supplied through the second hydrogen supply valve, the controller operates in a low output hydrogen constant pressure mode and transmits a load decrease request signal to a vehicle controller of a flight vehicle employing the fuel cell system.

13. The fuel cell system of claim 12, wherein, when operating in the low output hydrogen constant pressure mode, the controller initiates an emergency landing using the vehicle controller.

14. The fuel cell system of claim 13, further comprising:
a high-voltage battery configured to be charged by power generated by the fuel cell stack during the emergency landing.

15. The fuel cell system of claim 14, wherein the high-voltage battery supplies driving power to the flight vehicle during the emergency landing.

16. The fuel cell system of claim 13, wherein, responsive to a completion of the emergency landing, the controller outputs a message requesting charging of the hydrogen tank.

17. A processor-implemented method, the method comprising:
identifying a state of a hydrogen tank during an operation of a fuel cell stack powered by hydrogen from the hydrogen tank; and
controlling a supply of the hydrogen to one of a first hydrogen supply line comprising a first hydrogen supply valve configured to variably adjust a hydrogen supply pressure and a second hydrogen supply line comprising a second hydrogen supply valve configured to adjust the hydrogen supply pressure to a constant pressure, according to the state of the hydrogen tank.

18. The method of claim 17, wherein the identifying of the state of the hydrogen tank comprises:
determining whether a reference pressure condition of the hydrogen tank is satisfied when an internal pressure of the hydrogen tank exceeds a reference pressure or a state of fuel (SoF) of the hydrogen tank exceeds a reference value when the internal pressure and the SoF of the hydrogen tank are identified.

19. The method of claim 18, wherein the controlling of the supply of the hydrogen comprises:
controlling the supply of the hydrogen through the first hydrogen supply line when the state of the hydrogen tank satisfies the reference pressure condition.

20. The method of claim 18, wherein the controlling of the supply of the hydrogen comprises:
controlling the supply of the hydrogen through the second hydrogen supply line when the state of the hydrogen tank does not satisfy the reference pressure condition.

21. The method of claim 20, wherein, responsive to the state of the hydrogen tank not satisfying the reference pressure condition:
operating in a low output hydrogen constant pressure mode when the hydrogen is supplied through the second hydrogen supply line;
guiding an emergency landing of a flight vehicle employing the fuel cell stack;
charging a high-voltage battery using power generated by the fuel cell stack while the emergency landing of the flight vehicle is attempted; and
supplying driving power from the high-voltage battery to the flight vehicle.

22. A processor-implemented method, the method comprising:
controlling, responsive to a determined state of the hydrogen tank, a first port through which a supply of hydrogen being supplied from a hydrogen tank is introduced;
controlling, responsive to the determined state of the hydrogen tank, a second port configured to adjust a pressure of the hydrogen introduced through the first port and discharge the pressure-adjusted hydrogen through a first hydrogen supply line to a fuel cell stack;
controlling, responsive to the determined state of the hydrogen tank, a third port configured to adjust the pressure of the hydrogen introduced through the first port and discharge the pressure-adjusted hydrogen through a second hydrogen supply line to the fuel cell stack; and
entering a low output hydrogen constant pressure mode responsive to the determined state of the hydrogen tank not satisfying a reference pressure condition, the low output hydrogen constant pressure mode comprising:
controlling the third port to supply the hydrogen through the second hydrogen supply line; and
charging a high-voltage battery using power generated by the fuel cell stack.

23. The method of claim 22, wherein the low output hydrogen constant pressure mode further comprises initiating an emergency landing of a flight vehicle receiving power from the fuel cell stack.

24. The method of claim 22, wherein the low output hydrogen constant pressure mode further comprises supplying driving power to a flight vehicle employing the fuel cell stack using the high-voltage battery.
